(19) United States
(12) Patent Application Publication
(10) Pub. No.: US 2025/0358172 A1
(43) Pub. Date: Nov. 20, 2025

(54) Automation System and Method for Investigating, In the Automation System, The Performance of a Wireless Communication Network

(71) Applicant: ABB Schweiz AG, Baden (CH)

(72) Inventors: Zhibo Pang, Västerås (SE); Juha Mirsch, Helsinki (FI); Pawel Wiatr, Upplands Väsby (SE); Ognjen Dobrijevic, Västerås (SE)

(21) Appl. No.: 18/870,916

(22) PCT Filed: Jun. 10, 2022
(86) PCT No.: PCT/EP2022/065909

§ 371 Date: Dec. 2, 2024

(51) Int. Cl. H04L 41/0654; H04L 43/0829; H04L 43/0864; H04L 67/12

(52) U.S. Cl. CPC H04L 41/0654; H04L 43/0829; H04L 43/0864; H04L 67/12

(57) ABSTRACT

An automation system having an automation function environment including at least one automation function, a first performance inspecting function as well as a hardware assigning function and hardware for the at least one automation function and the first performance inspecting function, where a first automation function controls an automation device in a first automation equipment environment via a wireless communication network using hardware in the automation function environment that has been assigned to the first automation function by the hardware assigning function and the first performance inspecting function inspects the performance of the wireless communication network and performs a first performance failure handling activity in the automation function environment if the performance fails a corresponding performance criterion.

### TECHNICAL FIELD

The present disclosure relates to an automation system as well as to a method for investigating, in the automation system, the performance of a wireless communication network.

### BACKGROUND

With the introduction of cloud and edge computing, automation functions, such as motor and robot control functions, can be placed in the cloud or in an edge node. The automation function may then communicate with an automation device in an automation equipment environment in which the function is performed via a wireless communication network.

One type of cloud implemented automation function controlling automation equipment is disclosed in “Intelligent Edge Control with Deterministic-IP based Industrial Communication in Process Automation”, by Amjad Badar et al., 15th International Conference on Network and Service Management (CNSM), October 2019, where virtual controllers in the cloud are used for controlling a Bioreactor via a cellular network.

However, for some automation functions to work, it is in many cases necessary that the latency of the wireless communication network is low.

One document where latency is considered is US 2021/0229272. In this document a robot cell controller in a cloud computing domain controls robot devices in a robot cell domain via a wireless access domain. Furthermore, autonomous operation of a robot device is continued by the robot device if no control command is expected to be received due to delays associated with the wireless access domain.

Another document that considers problems with wireless communication networks is US 2021/0323159. This document discusses an end device, such as a robot, that is controlled by an edge server via a wireless network. If there is a failure of a wireless connection state with the edge server, through a signal not being received or the reception strength being too low, the end device may suspend its operation.

There is in view of what is mentioned above a need for handling problems associated with a wireless communication network for an automation function in an automation control environment that communicates with an automation device in an automation equipment environment via the wireless communication network.

### SUMMARY

One objective of the invention is therefore to handle problems of a wireless communication network for an automation function in an automation control environment communicating with an automation device in an automation equipment environment via the wireless communication network.

According to a first aspect there is presented a method for investigating, in an automation system, the performance of a wireless communication network, the automation system comprising an automation function environment in contact with a first automation equipment environment via the wireless communication network, where a first automation function in the automation function environment controls an automation device in the first automation equipment environment using hardware in the automation function environment that has been assigned to the first automation function by a hardware assigning function, the method comprising:
inspecting, in the automation function environment, the performance of the wireless communication network, and
performing a first performance failure handling activity in the automation function environment in case the performance fails to meet a corresponding performance criterion.

According to a second aspect, there is provided an automation system comprising
an automation function environment comprising at least one automation function, a first performance inspecting function as well as a hardware assigning function and hardware for the at least one automation function and first performance inspecting function, where a first automation function in the automation function environment controls an automation device in a first automation equipment environment via a wireless communication network using hardware in the automation function environment that has been assigned to the first automation function by the hardware assigning function; and
the first automation equipment environment comprising the automation device, wherein
the first performance inspecting function is configured to inspect the performance of the wireless communication network and perform a first performance failure handling activity in the automation function environment in case the performance fails to meet a corresponding performance criterion.

Furthermore, the performance inspection made in the automation function environment may be an inspection of the performance of the wireless communication network and the hardware assigned to the first automation function.

The performance inspection may additionally concern latency and/or reliability as well as possibly also statistics of latency and/or reliability.

The performance inspection may additionally comprise inspection of time critical messages exchanged between the first automation equipment environment and the automation function environment.

The hardware of the automation function environment may comprise two or more processing entities, two or more memory entities and possibly also two or more wireless communication entities. There may additionally be hardware for implementing the hardware assigning function in the automation function environment.

Hardware in the automation function environment running the hardware assigning function may be seen as forming a hardware assigning unit.

It is furthermore possible that the hardware assigning unit also assigns hardware to the first performance inspecting function or that the first performance inspecting function is provided through a first performance inspecting unit comprising dedicated hardware that implements the first performance inspecting function.

The automation function environment may be a virtual cloud-based automation function environment where the first automation function is a virtual controller and the hardware assigning function is a virtualization layer, while the first automation equipment environment may be a real automation environment where the automation device is a real automation device. Alternatively, the automation function environment and the first automation function may be provided in an edge node communicating with the first automation equipment environment.

The wireless communication network may be a part of the automation system or external to the automation system.

The automation device may comprise an electric machine, such as an electric motor, and a drive for the electric machine. The load may in turn comprise a pump, a crane, a robot arm, a conveyer belt, a grinding machine, a roll, a compressor or a power generator. In the case of a robot arm, at least a joint of this robot arm may be operated by the electric machine.

The first performance failure handling activity may be an error handling activity in or for the first automation function and/or may comprise a change of assigned hardware to the first automation function.

According to the first aspect, the method may furthermore comprise
inspecting in the first automation equipment environment, the performance of the wireless communication network, and
performing a second performance failure handling activity in the first automation equipment environment in case the performance fails to meet the corresponding performance criterion.

According to the second aspect, the first automation equipment environment may additionally comprise a performance inspecting unit implementing a second performance inspecting function, which second performance inspecting function is configured to inspect the performance of the wireless communication network and perform a second performance failure handling activity in the first automation equipment environment in case the performance fails to meet the corresponding performance criterion.

The performance criterion may thus be the same in the automation function environment and the first automation equipment environment.

The performance inspection being carried out in the automation function environment may additionally be coordinated with the performance inspection being carried out in the first automation equipment environment.

Furthermore, the performance inspection made in the first automation equipment environment may be an inspection of the performance of the wireless communication network and the hardware assigned to the first automation function.

The second performance failure handling activity may be a safety activity in the first automation equipment environment.

The performance inspection made by the first performance inspecting function in the automation function environment and by the second performance inspecting function in the first automation equipment environment may concern latency and/or reliability, where the reliability may be the reliability in upholding a certain degree of determinism or latency. The performance inspection may additionally or instead concern statistics of the latency and/or reliability.

The first automation equipment environment may comprise at least one sensor sensing at least one physical property in the first automation equipment environment.

It is additionally possible that time critical messages are exchanged between the first automation equipment environment and the automation function environment. The time critical messages may comprise sensors messages from the at least one sensor to the first automation function and control messages from the first automation function to the automation device.

The performance inspection made in the automation function environment and in the first automation equipment environment may comprise inspection of single trip time, round-trip time and/or message delivery rate of the time critical messages.

The performance inspection may additionally comprise an inspection of the time of sending of a first message and the time of reception of a second associated message, where one of the messages is a sensor measurement and the other is a control command affecting a physical property reflected in the sensor measurement. The first message may be sent before the reception of the second message. In case the performance inspection is made by the first performance inspecting function, the first message may be a control command, and the second message may be a sensor measurement of a physical property that has been changed by the control command. In case the performance inspection is made by the second performance inspecting function, the first message may be a sensor measurement, and the second message may be a control command that is determined based on the sensor measurement.

It is additionally possible that there is a unique identifier for the automation device or the first automation equipment environment.

In this case the method may additionally comprise obtaining, in the automation function environment, the unique identifier from the first automation equipment environment, comparing the obtained identifier with an identifier provided for the automation device or the first automation equipment environment in an authentication system and allowing the first automation function to operate in the first automation equipment environment if the identifiers match and otherwise disallowing operation.

In this case the first performance inspecting function may be additionally configured to obtain the unique identifier from the first automation equipment environment, compare the obtained identifier with an identifier provided for the automation device or the first automation equipment environment in an authentication system and allow the first automation function to operate in the first automation equipment environment if the identifiers match and otherwise to disallow operation.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a diagram schematically illustrating an automation system comprising an automation function environment and a number of automation equipment environments connected to the automation function environment via a wireless communication network;

FIG. 2 is a diagram schematically illustrating hardware units in the automation function environment;

FIG. 3 is a diagram schematically illustrating one realization of a first performance inspecting unit in the automation function environment implementing a first inspecting investigating function;

FIG. 4 is a diagram schematically illustrating one realization of a second performance inspecting unit in a first automation equipment environment and implementing a second performance inspecting function;

FIG. 5 is a flowchart schematically illustrating a number of method steps for investigating integrity in the automation system and being performed by the first performance inspecting function; and

FIG. 6 is a flow chart of a number of method steps in a method of investigating reliability of the automation system and being performed by the first and second performance inspecting functions.

### DETAILED DESCRIPTION

Aspects of the present disclosure will now be described more fully hereinafter with reference to the accompanying drawings, in which certain embodiments are shown.

These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

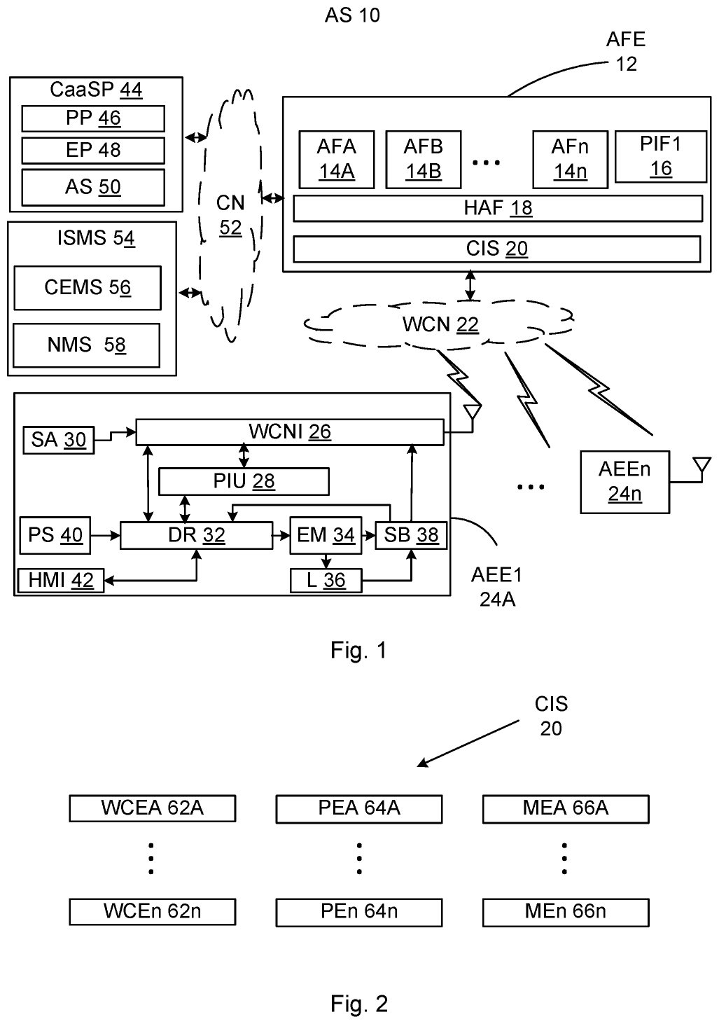

FIG. 1 is a diagram schematically illustrating an automation system AS 10, which automation system 10 comprises an automation function environment AFE 12, a number of automation equipment environments including a first automation equipment environment AEE1 24A and an nth automation equipment environment AEEn 24n. The automation system 10 also comprises a Control-as-a-Service (CaaS) platform CaaSP 44 and an infrastructure management system ISMS 54. Moreover, the automation function environment 12 is in contact with the automation equipment environments 24A, 24n via a wireless communication network 22, which may be an external wireless communication network, such as a public wireless communication network, or an internal wireless communication network, i.e. a wireless communication network that is a part of the automation system 10. Furthermore, the wireless communication network 22 may be a deterministic network, i.e. a network where the delay or latency is limited through the network guaranteeing that messages are being transferred in a set time period.

The automation function environment 12 communicates with the CaaS Platform 44 and the infrastructure management system 54 via a computer network CN 52, which may be an external computer network such as the Internet or an internal computer network, such as an Intranet.

The automation function environment 12 comprises a computing infrastructure CIS 20 and a hardware assigning function HAF 18. The automation function environment 12 may as an example be a virtual cloud-based automation function environment, while the automation equipment environment is a real automation environment where the automation device is a real or physical automation device. In this case the computing infrastructure CIS 20 may be a cloud computing infrastructure and the hardware assigning function HAF 18 may be a virtualization layer for virtualizing cloud functionality. The hardware assigning function 18 may be implemented or run on dedicated hardware of the computing infrastructure 20. The hardware in the automation function environment running the hardware assigning function may be seen as forming a hardware assigning unit.

As the environment is an automation function environment, the environment also comprises a number of automation functions. In this case it comprises a first automation function AFA 14A, a second automation function AFB 14B and an nth automation function AFn 14n, which automation functions in this case may be realized as virtual controllers implemented using the computing infrastructure 20 based on a mapping made by the hardware assigning function 18 to hardware of the computing infrastructure 20. Alternatively, the automation function environment 12 and the automation functions 14A, 14B, 14n may be provided in an edge node communicating with the automation equipment environment. An automation function may control one or more automation devices in a corresponding automation equipment environment. The automation function environment also comprises a first performance inspecting function PIF1 16.

Exemplifying elements of the first automation equipment environment 24A are also shown. The first automation equipment environment 24A comprises a wireless communication network interface WCNI 26 for connection to the wireless communication network 22. It also comprises at least one sensor sensing at least one physical property in the first automation equipment environment 24A. In the present example there is a first group of sensors SA 30 and a second group of sensors SB 38. The first automation equipment environment 24A also comprises an automation device connected to a load L 36. As an example, the automation device comprises an electric machine EM 34 and a drive DR 32 for the electric machine 34. There is also a power supply PS 40 for supplying power to the drive 32 as well as a human machine interface HMI 42 connected to the drive 32. There is also a second performance inspecting unit PIU 28 connected to the wireless communication network interface 26 and the drive 32, which second performance inspecting unit 28 implements a second performance inspecting function PIF2 80, see FIG. 4. The second performance inspecting unit 28 may additionally be connected to the first group of sensors 30 and/or the second group of sensors 38.

The second group of sensors 38 is connected to the electric machine 34 as well as to the load 36. The electric machine 34 drives the load 36 and this influences the second group of sensors 38. Thereby the second group of sensors are able to detect changes in the electric machine 34 and in the load 36. The first and second groups of sensors 30 and 38 are connected to the wireless communication network interface 26 for sending sensor measurements to the automation function environment 12 and more particularly to an automation function that controls the automation device of the first automation equipment environment 24A, such as the first automation function 14A. The sensor measurements from the second group of sensors 38 are influenced by the operation of the automation device, while the sensor measurements of the first group of sensors 30 are uninfluenced by the operation of the automation device. In the automation device, such as in the drive 32, there may also be a unique identifier, which identifier identifies the automation device or the automation equipment environment.

The other automation equipment environments may have similar elements and devices. However, it should be realized that the automation devices, loads and sensors may also differ from automation equipment environment to automation equipment environment. There may additionally be more than one automation device in an automation equipment environment.

FIG. 2 schematically shows an example of the computing infrastructure 20 of the automation function environment 12. The computing infrastructure 20 may comprise hardware resources in the form of a number of wireless communication entities, a number of processing entities and a number of memory entities. The hardware may comprise two or more processing entities, two or more memory entities and possibly also two or more wireless communication entities. As an example, there is here a first and an nth wireless communication entity WCEA 62A and WCEn 62n, a first and an nth processing entity PE 64A, PEn 64n and a first and an nth memory entity MEA 66A, MEn 66n. A wireless communication entity 62A, 62n may be realized as a radio circuit for wireless communication with the wireless communication network 22, a processing entity 64A, 64n may be realized as a processor such as a processing blade and a memory entity 66A, 66n may be realized as a memory blade. Here it should be realized that the number of entities of the different groups may differ even though the figure indicates that they have the same number n.

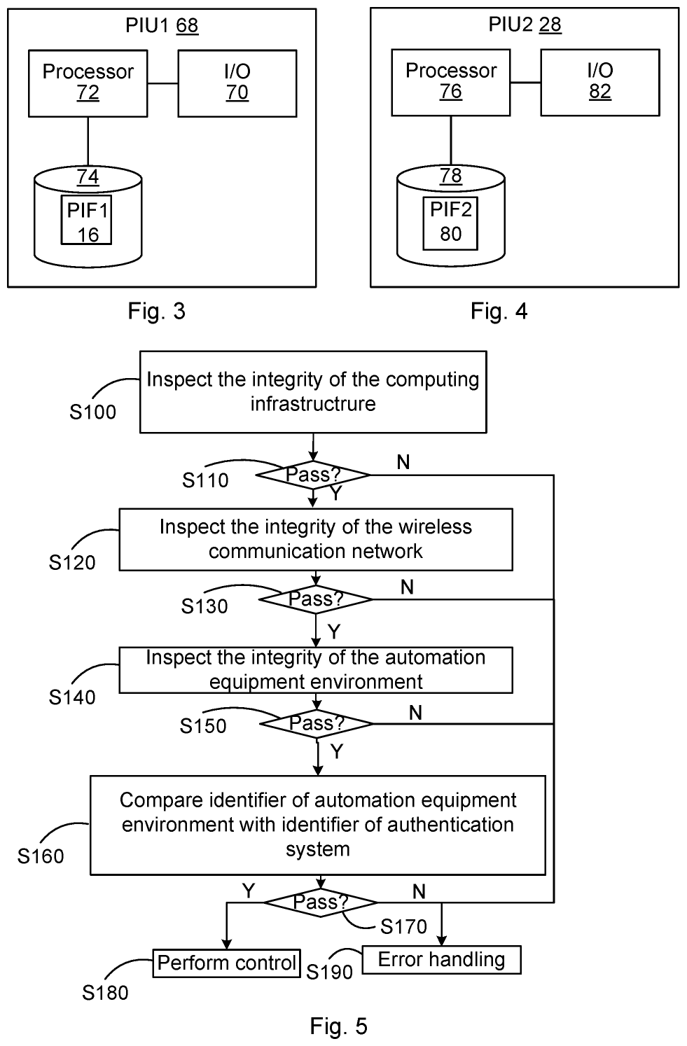

A first performance inspecting unit that performs the first performance inspecting function 16 may be realized using one or more hardware resources of the computing infrastructure 20 being assigned by the hardware assigning function 18. However, it is also possible that the first performance inspecting unit is implemented using dedicated hardware. FIG. 3 is a diagram schematically showing one such realization of the first performance inspecting unit PIU1 68 that comprises dedicated hardware that implements the first performance inspecting function 16. There is a processor 72 and a data storage 74 with computer program instructions that, when executed by the processor 72, implement the first performance inspecting function 16. There is also an input/output (I/O) interface 70 for communication with a corresponding wireless communication network interface as well as with hardware implementing the first automation function 14A.

FIG. 4 is a diagram schematically showing one simplified realization of the second performance inspecting unit 28 in the first automation equipment environment 24A. There is a processor 76 and a data storage 78 with computer program instructions that, when executed by the processor 76, implements the second performance inspecting function PIF2 80. There is also an input/output (I/O) interface 82 for communication with the corresponding wireless communication network interface 26 as well as perhaps with the first and second groups of sensors 30, 38 and/or the drive 32.

As is illustrated in FIG. 1, in the proposed automation system 10, the control software provided by the automation functions and the controlled equipment as exemplified by automation device is partitioned into an automation function environment 12 and one or more automation equipment environments 24A, 24n, where an automation equipment environment is an environment where physical automation equipment is provided, such as sensors and the automation device. The automation function environment 12 and automation equipment environments 24A, 24n are interconnected through the wireless communication network 22, which can be realized by e.g. the 5G, 6G, WiFi 6, WiFi 7, WiMAX or satellite broadband with the enhancement for deterministic performances, or a mixture of these wireless networks. The wireless communication network 22 may additionally be capable of providing deterministic performances including low and bounded latency, high reliability, and qualified to elaborate a black channel for safety communication layer according to the IEC standard IEC61508.

The entire automation system 10 may be integrated with a user business process through the automation function environment 12 over the computer network 52, so that the user's direct interventions to the automation equipment environments can be minimized throughout the entire life cycle of the automation system. The computer network 52 doesn't need to provide the deterministic performances.

The entire automation system 10 may be programmed and engineered through the Control-as-a-Service (CaaS) Platform 44, which for this reason may comprise a Programming Platform PP 46 and an Engineering Platform 48. The CaaS Platform 44 may additionally comprise an Authentication System AS 50 in which is stored the unique identifiers associated with the automation devices and/or automation equipment environments. As an embodiment, the CaaS Platform 44 is only accessible by professional CaaS providers instead of the users themselves.

In the first automation equipment environment 24A, the traditional hardware controllers in the field are removed. Instead, the control logic is executed by the automation functions, e.g. Soft Controllers, hosted by processing and memory hardware resources in the computing infrastructure 20, which can be realized by the ABB Ability, GE Predix, Siemens MindSphere, Microsoft Azure, Amazon Web Services, Alibaba Cloud, Huawei Mobile Cloud, etc. The control logic of the automation functions can be programmed in the PLC-specific languages such as IEC61131-3 and IEC61499, or generic programming languages such as C/C++. The automation function environment 12 may additionally support multitenancy, i.e., it may be capable of instantiating multiple automation functions 14A, 14B, 14n to control multiple automation equipment environments 24A, 24n in parallel without interferences to each other. The automation functions 14A, 14B, 14n may be hardware agnostic, i.e., they may be realized in the virtualized computing and communication environment over the hardware assigning function 18, such as with Docker containers and/or virtual machines of Linux, Windows, VxWorks, etc. It should also be realized that other functions than control can be offloaded from the automation equipment environment to the automation function environment, such as the HMI.

The computing infrastructure 20 and the hardware assigning function 18 may be managed by a computer management system CEMS 56 and the wireless communication network 22 may be managed by a network management system NMS 58 of the infrastructure management system 54. The infrastructure management system 54 can be operated by the user of the automation system or by a third party. The computing infrastructure 20 as well as the wireless communication network 22 and computer network 52 can be deployed as private facility or as public facility which can be shared among multiple users. As an embodiment, the infrastructure management system 54 is only accessible by professional infrastructure providers or operators instead of the users themselves.

The automation equipment environments comprise the physical devices used in the automation. The first automation equipment environment 24A does as an example comprise the power supply 40, the drive 32, the electric machine 34, the human machine interface 42, the load 36 and the first and second groups of sensors 30 and 38. The physical devices can have separate or shared wireless communication network interface(s). The physical devices can be connected to the wireless communication network interface 26 through wired field buses such as Modbus, Modbus TCP, PROFIBUS, PROFINET, EtherCAT, EtherNet/IP, CAN, DeviceNet, Ethernet Powerlink, CC-Link, TSN, ordinary Ethernet, IP, TCP/UDP, and/or directly via analog or digital input and output ports. The drive 32 performs basic control functionalities such as speed control, torque control, frequency control, voltage control, and safety protections. Time-critical sensing data and control commands are all transmitted over the wireless communication network 22. Such sensing data and control commands include but are not limited to setpoints of speed/frequency/torque, actual speed/frequency/torque, temperature, current voltage, flow, pressure, etc.

As an embodiment, the first and second groups of sensors 30 and 38 can be but are not limited to speed sensor such as encoder or resolver, current sensor, voltage sensor, power quality sensor, temperature sensor, pressure sensor, flow sensor, etc.

As an embodiment, the load 36 can be but is not limited to pumps, cranes, robot arms, conveyer belts, grinding machines, rolls, compressors, power generators, etc.

The automation device does not necessarily have to comprise an electric machine, such as a motor, but can for instance instead comprise a mechanical power transmission system, gears, etc.

Before an automation equipment environment is put to use, it is advantageous that it and the wireless communication network is investigated concerning integrity. This may be important in order to ensure that an automation function runs as smoothly as possible.

How this may be done, will now be described with reference being made to FIG. 5, which shows a number of steps being performed by the first performance inspecting function 16 of the automation function environment. The steps will additionally be described in relation to the first automation function 14A and the first automation equipment environment 24A, where the first automation function 14A in the automation function environment 12 controls the automation device in the first automation equipment environment 24A. Similar functionality may be implemented in relation to the other automation functions and automation equipment environments.

Before such control is performed the hardware assigning function 18 has assigned hardware resources to the first automation function 14A. This may involve assigning processing resources and memory resources. It may also involve assigning wireless communication resources. It is for instance possible that the first automation function 14A has been assigned the first processing entity 64A, the first memory entity 66A and the first wireless communication entity 62A. The hardware assigning function 18 may also be implemented in hardware. However, as opposed to the hardware used by the automation functions, this hardware may be dedicated.

The investigation concerning integrity may then start by the first performance inspecting function 16 inspecting the integrity of the computing infrastructure 20, S100, which may comprise investigating the integrity of the hardware assigned to the first automation function 14A by the hardware assigning function 18. For this reason, the first performance inspecting function 16 may investigate the operation of the hardware of the automation function environment 12 with regard to memory usage and processing, where the investigating of integrity may involve investigating that a hardware resource is functioning correctly, i.e. that it is not faulty. The first performance inspecting function 16 may then compare the inspected integrity with a corresponding integrity criterion, which may be that the entity is functioning properly. In case the criterion is not met, S110, then error handling is performed, S190. This may involve the first performance inspecting function 16 ordering the hardware assigning function 18 to change the hardware assigned to the first automation function 14A.

If the criterion is met, S110, then the first performance inspecting function 16 continues and inspects the integrity of the wireless communication network 22, S120.

The inspecting of integrity may comprise inspecting if messages are being sent to and received from the first automation equipment environment 24A, i.e. if a message that is sent to the first automation equipment environment 24A is actually received there. This may be done through investigating if a sent message is acknowledged or through sending a request for a sensor measurement to a sensor, for instance a sensor in the first group of sensors 30, and receiving a sensor measurement as a response to the request.

The integrity criterion may be that the wireless communication network is functioning properly, i.e. that the automation function environment 12 and first automation equipment environment 24A are able to communicate with each other, which may be found out through various messages actually being received or through a connection being set up to the wireless communication network 22. In case the criterion is not met, S130, then error handling is performed, S190. Error handling may involve a number of measures. It may involve instructing the hardware assigning function 18 to change wireless communication entity assigned to the first automation function 14A or it may involve instructing the first automation function 14A to connect to another automation equipment environment. It may also involve notifying the network management system 58 to make network changes allowing the criterion to be fulfilled.

If the communication criterion is found to be met, S130, then an automation equipment environment investigation is made regarding integrity of the first automation equipment environment 24A, S140. The investigation of integrity may involve the first performance inspecting function 16 requesting sensor measurements from the first and second group of sensors 30 and 38 and investigating if such measurements are received as a response and, if they are, that the measurements are feasible. The investigation of integrity may also involve sending a first request for sensor measurements to the second group of sensors 38, receiving a first response from the second group of sensors 38 with a first collection of sensor measurements, sending an automation command to the automation device, sending a second request for sensor measurements to the second group of sensors 38, receiving a second response from the second group of sensors 38 with a second collection of sensor measurements, investigating differences between the first and second collections of sensor measurements and determining that the automation device is operational if the differences indicate an operation corresponding to the command.

It is additionally or instead possible that the second performance inspecting function 80 performs an inspection of integrity and reports the result to the first performance inspecting function 16.

If the integrity criterion is not fulfilled, S150, then error handling is performed by the first performance inspecting function 16. This may involve selecting another automation equipment environment for the first automation handling function 14A. It may also involve indicating that operation is not possible.

However, if the integrity criterion is found to be fulfilled, S150, then the first performance inspecting function 16 continues and checks the authentication information of the authentication system, which may involve obtaining the unique identifier from the automation equipment environment, such as from the drive 32, comparing the obtained identifier with an identifier provided for the automation device or the first automation equipment environment 24A in the authentication system 50, S160, and allowing the first automation function to operate in the first automation equipment environment 24A if the identifiers match and otherwise to disallow operation.

There is thus an investigation of whether the unique identifier of the automation device and/or the first automation equipment environment 24A can be found in the authentication system 50, S160. For this reason, the first performance inspecting function 16 may interrogate the drive 32 about the unique identifier.

If the identifier can be found, S170, then the first automation function 14A starts to operate and to operate in the first automation equipment environment 24A, S180, which may involve controlling the automation device formed by the drive 32 and the electric machine 34. However, if the identifier cannot be found, S170, error handling is performed, S190, which involves the first automation function 14A not being allowed to operate in the first automation equipment environment 24A.

If all the investigations are successful, the first automation function 14A may then start to control the automation device in the first automation equipment environment 24A via the wireless communication network 22.

The above-mentioned investigations were made for the first automation equipment environment 24A. The same type of investigations may be made for the other automation equipment environments. It is also possible that the investigation of the integrity of the computing infrastructure 20 and the investigating of the integrity of the wireless communication network 22 is made at the same time for all the automation equipment environments followed by separate inspections of the integrity and unique identifier of each automation equipment environment.

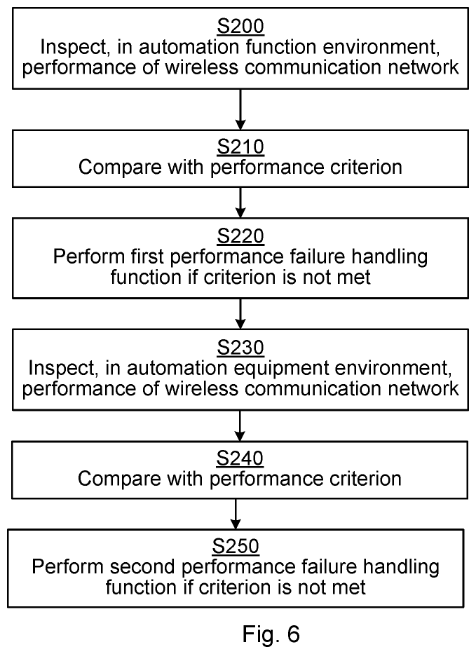

Although the wireless communication network 22 may be considered to be deterministic, it is still possible that the reliability or determinism is not upheld during operation. This may be problematic both for the first automation function 14A as well as in the first automation equipment environment 24A. Aspects of the present disclosure are directed towards handling this situation which is done through the employment of the first and optionally also of the second performance inspecting function 16, 80. How this can be carried out will now be described with reference being made to FIG. 6, which shows a flow chart of a number of method steps in a method of investigating reliability in the automation system and being performed by the first and optionally also the second performance inspecting function 16, 80.

During the performing of the method, the first automation function 14A is controlling the automation device in the first automation equipment environment 24A and in this operation it may obtain sensor measurements from the first and second groups of sensors 30 and 38 on which it determines a control activity. After having determined the control activity, the first automation function 14A then sends a control command to the automation device to perform the control activity, such as a drive command to the drive 32 to operate the electric machine 34 in a certain way, as well as receives sensor measurements of the second group of sensors 38 on which it determines that the control activity has been performed by the automation device. The above-described type of operation may be continuously or repeatedly performed. These commands and sensor measurements are used in the control, they are time-critical or time-sensitive. The commands and sensor measurements are sent in messages and these messages are time critical messages and may be vital for the time within which control is performed.

As the first automation function 14A operates in the above-described way, the first performance inspecting function 16 in the automation function environment 12 inspects the performance of the wireless communication network 22, S200. The performance inspection may additionally be an inspection of the performance of the wireless communication network and the hardware assigned to the first automation function. The inspecting may involve inspecting the latency and/or the reliability, which may be the latency and/or reliability of the wireless communication network 22 or the latency and/or reliability of the hardware assigned to the first automation function together with the wireless communication network, where the reliability may comprise the reliability in upholding a certain degree of determinism or latency.

The investigating of the determinism may involve inspecting a single trip time of messages received from the automation equipment environment and/or a round-trip time of messages sent by the first automation function 14A, which in this case involves the investigation of time critical messages exchanged between the first automation equipment environment 24A and the automation function environment 12. The single trip time may provide an indication of the latency or delay that messages received from the first automation equipment environment 24A experience through the wireless communication network 22. It may also be used as an indication of the latency or delay that messages sent from the automation function environment 12 experience in the wireless communication network 22. The round-trip time may provide an indication of the latency or delay that messages received from the first automation equipment environment 24A as well as the latency or delay that messages sent by the automation function environment experience in the wireless communication network 22. The messages may be time stamped, and the single trip time or single trip delay may be investigated through comparing the time of reception of a message with the time stamp of the message, while the round-trip time or round-trip delay may be investigated through sending a message to the first automation equipment environment that is returned by the first automation equipment environment 24A. The time of reception of the returned message is then compared with the time stamp or time of sending of the original message. It is also possible to determine the latency through sending a first message and receiving an associated second message, where one of the messages is a sensor measurement and the other is a control command affecting a physical property reflected in the sensor measurement. In this case the first message may be a control command, and the second message may be a sensor measurement of a physical property that has been changed by the control command. The first message may thus be sent before the second message is received. The time between the first and second message does not only consider the delay between the two messages in the wireless communication network 22 but also the time it takes to perform the activity of the control command in the first automation equipment environment 24A.

The first performance inspecting function 16 may additionally determine the latency of the assigned hardware based on the time it takes for the first automation function 14A to determine a control activity perhaps using one or more received sensor measurements. This may be based on the time of reception of a sensor measurement and the time of sending of a control command that has been determined based on the sensor measurement.

The investigation may additionally involve investigating how well the wireless communication network 22 fulfils performance criteria. It thus involves investigating whether the performance fulfils or fails at least one corresponding performance criterion. The investigating may thereby involve comparing the performance of the wireless communication network 22 and possibly also of the assigned hardware with at least one corresponding performance criterion, S210, where one performance criterion may concern the delay through the wireless communication network 22 and with which one or more thresholds may be associated, such as a threshold concerning a maximum allowed delay of a critical message, such as delay of a received single-trip message, a delay of a roundtrip message or a delay between the previously-mentioned first and second message. It is additionally possible that the latency of the assigned hardware is compared with a corresponding hardware latency threshold. It is also possible that the hardware latency is added to the single-trip delay, the round-trip delay and/or the delay between the first and second messages and compared with corresponding thresholds. The determinism criterion may then be considered fulfilled if one, more than one or all compared values fail to reach the corresponding threshold.

Another criterion may be concerned with the reliability of the wireless communication network 22 and possibly also of the assigned hardware. The inspecting of the reliability may involve inspecting the message delivery rate of time critical messages received from the automation equipment environment and/or sent by the first automation function 14A. It is also possible that the message delivery rate of the wireless communication network, e.g. the rate with which it is able to deliver messages between the two environments, is compared with a corresponding threshold. It is also possible that statistics of the previously mentioned single trip time, round-trip time and/or delay between the first and second messages, possibly combined with the hardware latency, is investigated. It is for instance possible to investigate if the single message delay, round-trip delay and delay between the first and second messages vary significantly over time or frequently fail to meet the corresponding thresholds. It is also possible to determine if the difference between the minimum and maximum such delay in a certain time window exceeds a corresponding difference threshold or that a count of delays that fail to meet the corresponding thresholds during a certain time window is compared with a count threshold. An exceeding of such a difference threshold and/or count threshold may then lead to the wireless communication network and optionally also the assigned hardware being deemed unreliable.

After having investigated the reliability and determinism of the wireless communication network 22 in this way, the first performance inspecting function 16 then performs a first performance failure handling activity in the automation function environment 12 in case the wireless communication network 22 is found to have a performance that fails a corresponding performance criterion, S220. This may be the performing of an error handling activity in or for the first automation function 14A. The error handling may for instance involve instructing the first automation function 14A to perform control error handling, such as to stop performing control of the automation device and instead enter into a fault handling or fail-safe mode, which fault handling or fail-safe mode may involve controlling the automation device to stay idle. This may be done because the automation function may be deemed to be too unreliable or too dangerous to perform. The error handling may also or instead involve the first performance inspecting function 16 asking the hardware assigning function 18 to assign new hardware to the first automation function 14A. This assigning of new hardware may involve assigning another wireless communication entity to the first automation function 14A. It is for instance possible that the delay through the wireless communication network is lower for another wireless communication entity. The assigning of a new hardware may additionally or instead be the assigning of another processing entity to the first automation function. Although such assigning does not influence the latency of the wireless communication network 22, it may influence the speed with which control commands are determined. It may thereby be possible to compensate for at least some of the delay of the wireless communication network 22 with a speeding up of the processing of sensor measurements into control commands. Thereby the total control may be improved. If the second performance inspecting function 80 is used, this function may be provided with information about such processing entity change for adjusting one or more of its thresholds. Also, the first performance inspecting function 16 may adjust one or more of its thresholds.

In a similar manner the second performance inspecting function 80 of the second performance inspecting unit 28 in the first automation equipment environment 24A may inspect the performance of the wireless communication network 22, S230. This inspection may be coordinated with the inspection being performed by the first performance inspecting function. The inspection being performed by the second performance inspecting function 80 may also involve the determinism or latency and/or the reliability of the wireless communication network 22 and possibly also of the assigned hardware, where the reliability may comprise the reliability in upholding a certain degree of determinism or latency. This inspection of wireless communication network latency may be performed in the same way and may as an example involve inspecting a single trip time of critical messages received from the automation function environment 12, a round trip time of time critical messages sent from the first automation equipment environment 24A. a message delivery rate of the time critical messages or the time difference or delay between a sent first message and a received associated second message, where one of the messages is a sensor measurement and the other is a control command affecting a physical property reflected in the sensor measurement. The single trip time and the round-trip time may be determined in the same way as in the first performance inspecting function. However, in this case the first message is a sensor measurement, and the second message is a control command that is determined based on the sensor measurement. The first message is also sent before the second message is received. The delay between the first and the second messages in this case also depends on the time required for the assigned hardware to determine the control command and thus also reflects the latency of the hardware assigned to the first automation function 14A. The second performance inspecting function 80 may also determine the time it takes to perform the activity of the control command in the first automation equipment environment, for instance through monitoring a time it takes for a physical property detected by an appropriate sensor in the second group of sensors to change based on the reception of a control command. The second performance inspecting function 80 may then compare this determined time with a corresponding threshold or add the determined time of the activity to one or more of the previously mentioned single-trip time, round-trip time and delay between first and second message.

The investigation may additionally involve investigating how well the wireless communication network and optionally also the assigned hardware fulfils performance criteria. It may thus comprise comparing the performance with at least one performance criterion, S240, which investigation and criteria may be the same as described above.

Also, statistics may be investigated, which may be done in the same way as by the first performance inspecting function 16.

Then if the wireless communication network is found to have a performance that fails the at least one performance criterion, the second performance investigating function 28 performs a second performance failure handling activity, S250, which as an example may involve placing the automation device in a safety mode, for instance through the drive 32 taking over the control of and stopping the load 36 into a safe state.

It can in this way be seen that the operation may be stopped or halted based on if the wireless communication network is deemed to be reliable and/or deterministic or not. Moreover, since the investigations are coordinated, the finding of the performance criterion not being fulfilled may be made simultaneously in the automation function environment and the first automation equipment environment.

It can be seen that the safety of operation may be guaranteed even though the control has been moved to the automation function environment and is performed via the wireless communication network.

It can be seen that performance inspecting functions are introduced in the automation function environment and possibly also in the automation equipment environment, which may work cooperatively to inspect the performances of the wireless communication network and possibly also of the computing infrastructure in terms of latency and reliability. The inspection may be performed in real-time by measuring e.g. single trip time, round trip time, message delivery rate, and their statistics of the time-critical messages exchanged between the automation function environment and automation equipment environment. The obtrusiveness introduced by the inspection operations to user's computing tasks and communication traffics can be minimized by using passive sniffing and hardware aided timestamping, which is commonly available as off-the-shelf products e.g., the ET2000 Ethernet probe from Beckhoff.

The outputs from the performance inspecting functions are used by the first automation function in the automation function environment, the automation device in the automation equipment environment, and possibly also by human users of the CaaS Platform and the Infrastructure Management Systems. For example, if a performance inspecting function indicates that the instantaneous latency and reliability performances of the communication and computing infrastructure cannot meet the expected level of determinism, the automation device should take over the control and place the load in a safe state, the automation function should activate predefined error handling logic accordingly, and the users of the CaaS platform and the infrastructure management systems may perform proper actions as well to improve the overall availability of the service.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

1. A method for investigating, in an automation system, the performance of a wireless communication network, the automation system comprising an automation function environment in contact with a first automation equipment environment via the wireless communication network, where a first automation function in the automation function environment controls an automation device in the first automation equipment environment using hardware in the automation function environment that has been assigned to the first automation function by a hardware assigning function,
the method comprising:
inspecting, in the automation function environment, the performance of the wireless communication network, and
performing a first performance failure handling activity in the automation function environment in case the performance fails to meet a corresponding performance criterion.

2. The method according to claim 1, wherein the performance inspection is an inspection of the performance of the wireless communication network and the hardware assigned to the first automation function.

3. The method according to claim 1, wherein the performance inspection concerns latency and/or reliability.

4. The method according to claim 1, wherein the performance inspection comprises inspecting time critical messages exchanged between the first automation equipment environment and the automation function environment.

5. The method according to claim 4, wherein the performance inspection comprises inspection of single trip time, round trip time and/or message delivery rate of the time critical messages.

6. The method according to claim 4, wherein the first automation equipment environment comprises at least one sensor sensing at least one physical property in the first automation equipment environment and the time critical messages include sensors messages from the at least one sensor, to the first automation function and control messages from the first automation function to the automation device.

7. The method according to claim 6, wherein the performance inspection comprises inspecting the time of sending of a first message and the time of reception of a second associated message, where one of said messages is a sensor measurement and the other is a control command affecting a physical property reflected in the sensor measurement.

8. The method according to claim 1, wherein the first performance failure handling activity is an error handling activity in or for the first automation function.

9. The method according to claim 1, wherein the first performance failure activity includes a change of assigned hardware to the first automation function.

10. The method according to claim 1, further comprising
inspecting in the first automation equipment environment, the performance of the wireless communication network, and
performing a second performance failure handling activity in the first automation equipment environment in case the performance fails to meet the corresponding performance criterion.

11. The method according to claim 10, wherein the second performance failure handling activity is a safety activity in the first automation equipment environment.

12. The method according claim 1, further comprising obtaining, in the automation function environment, a unique identifier from the first automation equipment environment, which unique identifier is associated with the automation device or the first automation equipment environment, comparing the obtained identifier with an identifier provided for the automation device or the first automation equipment environment in an authentication system and allowing the first automation function to operate in the first automation equipment environment if the identifiers match.

13. An automation system comprising:
an automation function environment comprising at least one automation function, a first performance inspecting function as well as a hardware assigning function and hardware for the at least one automation function and first performance inspecting function, where a first automation function in the automation function environment controls an automation device in a first automation equipment environment via a wireless communication network using hardware in the automation function environment that has been assigned to the first automation function by the hardware assigning function; and
the first automation equipment environment including the automation device,
wherein the first performance inspecting function is configured to inspect the performance of the wireless communication network and perform a first performance failure handling activity in the automation function environment in case the performance fails to meet a corresponding performance criterion.

14. The automation system according to claim 13, wherein the automation function environment is a virtual cloud-based automation function environment where the first automation function is a virtual controller and the hardware assigning function is a virtualization layer, while the first automation equipment environment is a real automation environment where the automation device is a real automation device.

15. The automation system according to claim 13, wherein the automation function environment and the first automation function are provided in an edge node.

16. The method according to claim 2, wherein the performance inspection concerns latency and/or reliability.

17. The method according to claim 2, wherein the performance inspection comprises inspecting time critical messages exchanged between the first automation equipment environment and the automation function environment.

18. The method according to claim 2, wherein the first performance failure handling activity is an error handling activity in or for the first automation function.

19. The method according to claim, wherein the first performance failure activity includes a change of assigned hardware to the first automation function.
